(19) United States
(12) Patent Application Publication
(10) Pub. No.: US 2010/0194868 A1
(43) Pub. Date: Aug. 5, 2010

(54) SYSTEM, APPARATUS AND METHOD FOR FLEXIBLE MODULAR PROGRAMMING FOR VIDEO PROCESSORS

(76) Inventors: Daniel Peled, Jerusalem (IL); Yaron Magal, Givaat Shmuel (IL); Gilad Taub, Jerusalem (IL); Aryeh Batt, Metzador Yehuda (IL); Yishay Hayardeni, Jerusalem (IL)

Correspondence Address: DR. D. GRAESER LTD., 9003 FLORIN WAY, UPPER MARLBORO, MD, 20772, US

(21) Appl. No.: 12/519,166

(22) PCT Filed: Dec. 16, 2007
(86) PCT No.: PCT/IL2007/001555

§ 371 Date: Apr. 22, 2010

Related U.S. Application Data
(60) Provisional application No. 60/875,016, filed on Dec. 15, 2006.

(51) Int. Cl. G06F 15/16; H04N 7/18; H04N 5/225

(52) U.S. Cl. 348/61; 348/207.1; 345/502; 348/E05.062

(57) ABSTRACT

A system, apparatus and a method for providing a flexible framework for a video processing infrastructure to enable rapid integration of video analytics algorithms in video security systems. Such a flexible framework preferably features a plurality of ready-to-use libraries, as well as at least one “skeletal” module into which customized programming may be inserted. The skeletal module preferably comprises a generic customizable interface to a hardware device or system, described collectively herein as a video processor.

### FIELD OF THE INVENTION

The present invention is of a system, apparatus and method for programming for video processors, and in particular to such a system, apparatus and method which is sufficiently flexible to be operable with a plurality of differently configured video processors.

### BACKGROUND OF THE INVENTION

Video processors of various types are well known in the art. For example, currently different types of boards and cards include video processing capabilities. Chips are also available for processing video data. However, currently each such chip, board and/or card must have specially created programming for video processing to occur. Although it is possible to reuse certain elements of previously existing software, no solution exists that also provides the overall framework for the programming, nor does a solution exists which provides a “skeletal” solution into which the programmer may insert the desired programming. Such a solution would clearly be desirable because it would reduce the amount of programming time and person hours required to create software for each new chip, board or card, and as such would facilitate rapid adaptation of video technology for processing of video data.

The term “rapid adaptation” is typically used for object oriented programming and refers to the ability to quickly create new code based on existing code or objects. Code which may be rapidly used and reused, with changes as required to meet new requirements, is clearly desirable. However, such code must also be able to interact with a wide variety of hardware systems and interfaces, particularly for code that is to be placed on chips and other hardware devices. Thus, rapid adaptation is not always useful for such code because of the extensive changes that may currently be required.

### SUMMARY OF THE INVENTION

There is an unmet need for, and it would be highly useful to have, a system, apparatus and method for a flexible framework for video programming for a plurality of video processing architectures. There is also an unmet need for, and it would be highly useful to have, a system, apparatus and method for supporting rapid insertion of customized programming to such a framework. There is also an unmet need for, and it would be highly useful to have, a system, apparatus and method for a plurality of libraries to support such customized programming.

The system, method and apparatus overcome the above drawbacks of the background art by providing a flexible framework for a video processing infrastructure to enable rapid integration of video analytics algorithms. According to some embodiments of the present invention, such infrastructure may optionally and preferably be used in video security systems. Such a flexible framework preferably features at least one and more preferably a plurality of ready-to-use libraries, as well as at least one “skeletal” module into which customized programming may be inserted. The skeletal module preferably comprises a generic customizable interface to a hardware device or system, including but not limited to a chip, a core, a chipset, a board or a card, or a combination thereof or a plurality thereof, hereinafter collectively referred to as a video processor for the sake of clarity only, without any wish of being limiting.

The skeletal module preferably also comprises functionality for both digital and analog IP nodes, preferably adapted for video data, including but not limited to one or more of video grabbing and display, video manipulation (including but not limited to resealing and frame rate reduction), audio grab and play, video and audio streaming, dry contact input triggering and relay output, external device control using serial communications (including but not limited to PTZ (pan-tilt-zoom) control and other types of control for video cameras and other types of devices for collecting image data), and also one or more video overlay functions.

According to preferred embodiments of the present invention, the framework further comprises a skeletal video analytics engine which may be optionally be modified and/or replaced by a different video analytics engine. The framework preferably comprises a plurality of software hooks to enable an application feedback on video triggered events. More preferably, the framework further comprises inputs from other trigger sources, which most preferably are used in combination for controlling various activities on the video processor such as video streaming dry contact output etc.

According to some embodiments of the present invention, there is provided a method for providing a flexible framework for a video processing infrastructure, comprising: constructing a skeletal video analytics engine interface; and building an event manager for managing at least one event according to at least one analytic result provided from the skeletal video analytics engine interface. Optionally and preferably, the framework is adapted for use with a video processing infrastructure comprising a plurality of processors, wherein at least one processor is adapted for processing video data and wherein at least one processor is for general data processing.

Preferably, the method further comprises constructing at least one method for supporting at least one interaction between the event manager and at least one peripheral device. Also preferably, the skeletal video analytics engine interface is adapted for operating with a plurality of different video processing infrastructures.

Optionally and preferably, constructing the skeletal video analytics engine interface further comprises constructing a generic customizable interface to the video processing infrastructure. More preferably, the video processing infrastructure comprises at least one of a chip, a core, a chipset, a board or a card, or a combination thereof. Optionally and more preferably, the generic customizable interface supports one or more of the following functions: video grabbing and display, video manipulation, audio grab and play, video streaming, audio streaming, dry contact input triggering, dry contact relay output, external device control, and a video overlay function. Most preferably, video manipulation comprises one or more of resealing and frame rate reduction. Optionally and most preferably, the external device control comprises control of a video camera.

Optionally, external device control comprises TTL (transistor-transistor logic) inputs and outputs. Also optionally, the video processing infrastructure comprises the DaVinci architecture.

Optionally and preferably, the method further comprises Building a video analytics engine; and Receiving data by the video analytics engine through the skeletal video analytics engine interface. More preferably, the method further comprises analyzing the data by the video analytics engine; and determining at least one event according to the analyzing for handling by the event manager. Most preferably, determining the at least one event is performed by the video analytics engine. Also most preferably, determining the at least one event comprises detecting a threshold in the data by the video analytics engine and if the data is beyond the threshold, determining the at least one event. Optionally and most preferably, the method further comprises providing an identified event by the video analytics engine to the skeletal video analytics engine interface; and sending the identified event from the skeletal video analytics engine interface to the event manager.

Optionally, determining the at least one event is performed by the event manager.

Optionally, the method further comprises initiating communication with an external network according to the at least event. Preferably, initiating the communication comprises streaming video data to the external network. More preferably, streaming the video data is performed by a multimedia streaming engine (MMSE).

According to some embodiments, the method further comprises building a video analytics engine; replacing at least a portion of the skeletal video analytics engine interface with the video analytics engine; and connecting the video analytics engine directly to the event manager.

According to some embodiments, the present invention provides a system for implementing a flexible video processing framework for a video analytics engine, comprising: a. a plurality of processors, wherein at least one processor is adapted for processing video data and wherein at least one processor is for general data processing; b. a skeletal video analytics engine interface for supporting communication between the video analytics engine and at least the processor adapted for processing video data; and c. an event manager for managing at least one event according to at least analytic result provided from the skeletal video analytics engine interface. Preferably, the system further comprises a library featuring a plurality of different functions for extending the skeletal video analytics engine interface.

Optionally and preferably, the skeletal video analytics engine interface further comprises at least one software hook for engaging the video analytics engine. More preferably, the plurality of processors is constructed according to the DaVinci architecture.

Optionally, the system further comprises a video camera for providing video data to the skeletal video analytics engine interface. Also optionally, the system further comprises a network interface for interacting with an external computer network. Preferably, the system further comprises a multimedia streaming engine (MMSE), wherein the skeletal video analytics engine interface supports communication between the MMSE and the processors. More preferably, the MMSE streams video data through the external network upon detection of a triggering event by the event manager.

Optionally, MMSE supports one or both of RTP (Real Time Transport protocol) streaming transport protocol and RTSP (Real Time Streaming Protocol) control protocol.

Optionally, the system further comprises an OSD (on screen display) engine for interacting with the skeletal video analytics engine interface.

Optionally the event manager further comprises a response analyzer for comparing an event to at least one rule, and for determining at least one response according to the comparing. Preferably, the response analyzer further comprises a message transporter for sending a message for the response. More preferably, the message transporter operates according to at least one of e-mail, SMS (text messaging), and delivering an automated message by a voice telephony method. Optionally and more preferably, the response analyzer further comprises a TTL output response. Also optionally and more preferably, the event manager further comprises a TTL input for receiving transistor-transistor logic input, for combining with the analyzed video data by the response analyzer.

According to some embodiments of the present invention, there is provided a board for implementing the system as described herein. According to other embodiments of the present invention, there is provided a security system comprising the system as described herein, at least one a video camera for providing video data to the skeletal video analytics engine interface and at least one device adapted for TTL input and/or output.

According to still other embodiments of the present invention, there is provided a method for communication between a user interface and a chip architecture, wherein the architecture comprises a memory and a plurality of processors, wherein at least one processor is adapted for processing video data and wherein at least one processor is for general data processing, the method comprising: Constructing a skeletal interface for supporting communication with the processors; Sending a command through the skeletal interface to obtain data from the memory; and Providing the data to the user interface through the skeletal interface. Preferably, the command comprises a HTTP GET command. More preferably, the method further comprises sending data to the processors through the skeletal interface. Most preferably, sending the data is performed according to a HTTP POST command. Optionally and more preferably, the user interface comprises a web browser. Optionally and most preferably, the sent data comprises at least one configuration command. Also optionally and most preferably, the skeletal interface forms a part of the skeletal video analytics interface according to any of the preceding claims.

According to yet other embodiments of the present invention, there is provided a method for controlling access to instructions provided with hardware, comprising: providing hardware with instructions, wherein access to the instructions is blocked; receiving a code for accessing the instructions; and providing the code to the hardware to access the instructions.

Optionally, receiving the code further comprises purchasing access to the instructions. Preferably, the hardware is provided in the form of a card and/or as a plurality of components. More preferably, the hardware comprises a plurality of processors, wherein at least one processor is adapted for processing video data and wherein at least one processor is for general data processing. Most preferably, the hardware is constructed according to the DaVinci architecture.

As used herein, the term “video processor” optionally and preferably includes but is not limited to a core, chip, board, chip set, card, system on chip (SOC) chips and collections of chips and/or cores. According to preferred embodiments, the video processor comprises a plurality of cores, in which at least one core is adapted to processing of video data and at least one core is adapted for general data processing. The core adapted to processing of video data may optionally comprise a DSP. Any number of cores may optionally be featured, including but not limited to, two, three, four, five, six and/or higher numbers of cores, and/or pairs of cores.

Unless otherwise defined, all technical and scientific terms used herein have the same meaning as commonly understood by one of ordinary skill in the art to which this invention belongs. The materials, methods, and examples provided herein are illustrative only and not intended to be limiting.

Implementation of the method and system of the present invention involves performing or completing certain selected tasks or stages manually, automatically, or a combination thereof. Moreover, according to actual instrumentation and equipment of preferred embodiments of the method and system of the present invention, several selected stages could be implemented by hardware or by software on any operating system of any firmware or a combination thereof. For example, as hardware, selected stages of the invention could be implemented as a chip or a circuit. As software, selected stages of the invention could be implemented as a plurality of software instructions being executed by a computer using any suitable operating system. In any case, selected stages of the method and system of the invention could be described as being performed by a data processor, such as a computing platform for executing a plurality of instructions.

Although the present invention is described with regard to a “computer” on a “computer network”, it should be noted that optionally any device featuring a data processor and/or the ability to execute one or more instructions may be described as a computer or any other device/machine with processing capabilities, including but not limited to a PC (personal computer), a server, a minicomputer, a cellular telephone, a smart phone, a PDA (personal data assistant), a pager, TV decoder, game console, digital music player, ATM (machine for dispensing cash), POS credit card terminal (point of sale), electronic cash register. Any two or more of such devices in communication with each other, and/or any computer in communication with any other computer, may optionally comprise a “computer network”.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in order to provide what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIG. 1 is a schematic block diagram of an exemplary, illustrative system according to the present invention;

FIG. 2 is a schematic block diagram of an exemplary, illustrative event manager of FIG. 1 according to the present invention in more detail;

FIG. 3 is a schematic block diagram of an exemplary, illustrative board implementing the system of FIG. 1 according to the present invention;

FIG. 4 shows a more detailed schematic block diagram of an exemplary, illustrative board according to FIG. 3;

FIG. 5 shows an exemplary data flow for an exemplary and optional chip architecture that is operative with the present invention;

FIGS. 6A and 6B show exemplary, illustrative methods for implementing a video analytics engine according to FIG. 1;

FIG. 7 shows an exemplary, illustrative schematic block diagram of a portion of a system for implementing the OSD engine according to the present invention;

FIG. 8 shows an exemplary, illustrative method for implementing the system according to the present invention as part of an optional security system;

FIG. 9 shows an exemplary, illustrative method for controlling access to instructions provided with hardware according to some embodiments of the present invention; and

FIG. 10 relates to an exemplary, illustrative method for providing an XML interface for the card/hardware as a standard configurable fully customized API for the web interface.

### DESCRIPTION OF THE PREFERRED EMBODIMENTS

The present invention is of a system, apparatus and a method for providing a flexible framework for a video processing infrastructure to enable rapid integration of video analytics algorithms in video security systems. Such a flexible framework preferably features at least one and more preferably a plurality of ready-to-use libraries, as well as at least one “skeletal” module into which customized programming may be inserted. The skeletal module preferably comprises a generic customizable interface to a hardware device or system, described collectively herein as a video processor.

According to preferred embodiments of the present invention, there is provided an event manager for handling a plurality of different types of events, with regard to inputs and outputs to and from the video processor. The event manager supports the framework according to the present invention by providing generic event handling for the video processor, which may then optionally be integrated to the customized programming for the processor.

According to other embodiments of the present invention, the framework preferably comprises code which provides a plurality of methods for performing various interactions with the hardware of the video processor and/or surrounding hardware in the environment of the video processor, which are overall parts of the hardware system. More preferably, a plurality of methods is provided for each task to be performed through an interaction with the hardware system or at least through an interaction with the video processor.

The framework according to the present invention is preferably incorporated into a board which more preferably comprises a plurality of different functions, such as video encoding and analytics for example. Optionally one or more interfaces may be provided, such as digital CMOS, CCD and video analog input for example; such a combination for the interface may optionally and preferably be provided as the hardware platform for a smart IP camera. Alternatively or additionally, one or more different types of video and audio interfaces are provided. Also optionally, each board may comprise one or more computer network interfaces such as Ethernet, WiFi, WiMax, GPRS and/or any other suitable network interface.

According to preferred embodiments of the present invention, there is provided a multimedia streaming engine (MMSE). The engine preferably features a plurality of different functions, more preferably including one or more streaming protocols. Preferably, the MMSE supports the widely spread RTP (Real Time Transport protocol) streaming transport protocol along with RTSP (Real Time Streaming Protocol) control protocol. The RTSP enables control over remote multimedia streams. The RTP protocol is the transport by which the multimedia is streamed. RTP includes a few transport modes such as UDP Unicast and Multicast, TCP and HTTP.

According to other preferred embodiments of the present invention, the transport modes of the RTP transport protocol are supported by the present invention. For example, preferably UDP unicast is supported, in which the multimedia stream is packetized and sent using UDP unicast packets. This method is point to point. Using UDP to transfer the data enables low latency and minimizes the timing jitter, but does not guarantee the safe delivery of the data. This method should be used in a low error/low loss network medium like a LAN (local area network) for example.

Preferably UDP multicast is supported, which is similar to UDP unicast except that the multicast method supports transferring the data to multiple clients in the network with little traffic overhead. The data is transmitted once and the network equipment is responsible for distributing the data to all listening peers. Another preferably supported mode is the TCP interleaved mode, which is preferably used in high error/high loss media where guaranteed delivery is more important than latency TCP is used. The data is interleaved with the RTSP protocol.

HTTP interleaved mode is also preferably supported, which may be used to overcome network problems such as routers and firewalls. Many local area networks are gated by routers which separate them from the outside world. Many such networks employ NAT (Network Address Translation) and firewall port filtering. This method embeds the stream and RTSP negotiation in HTTP standard requests.

According to other preferred embodiments of the present invention, the MMSE supports both RTP/RTSP client and server functionality on boards according to the present invention. The server is preferably able to stream video and audio to remote clients. The client is preferably able to use digital video sources.

According to preferred embodiments of the present invention, there is provided a skeletal video analytics engine, which may optionally be modified or replaced by a different engine. The engine features a plurality of software hooks to various functions on the video processor, for ease of customizable programming. The framework also preferably comprises a sample code for supporting the functions of the analytics engine. The sample code more preferably demonstrates the use of the software hooks, such that the programmer may easily and rapidly adjust such code for each desired implementation, most preferably while maintaining the overall context of the framework. However, the sample code itself is preferably removed and/or overwritten by the programmer.

The framework according to the present invention preferably comprises skeletal code to support the analytics engine initialization parameters. Optionally and preferably, the skeletal code may be modified and/or partially or completely replaced with different code to initialize the analytics library.

The framework also preferably features a dummy parameter save system to provide illustrative code for saving parameters on the system storage (including but not limited to flash memory storage or any other type of suitable storage). More preferably, the code demonstrates the methods to save parameters on such storage, thereby most preferably providing the programmer with a plurality of choices for such methods from which the programmer may optionally and preferably select one or more methods for use.

A sample web page or web pages and/or any other type of documentation are preferably provided with the skeletal application to demonstrate a web based approach to system configuration and/or any other type of suitable system configuration. The documentation preferably demonstrates one or more system parameter settings, video analytics rule(s), alert and response management, status and reports and so forth.

The analytics engine output is preferably provided in the form of events which are preferably handled by the event manager, and which optionally and more preferably are sent to an external hardware device such as a computer or computers. To support transmission of data to an external hardware device, the skeletal application preferably provides at least one method, and more preferably a plurality of methods, to send the data over a computer network. Examples of such methods include but are not limited to Client/Server and HTTP (Hypertext Transfer Protocol) POST/GET commands. The latter type of commands are useful for any type of communication according to HTTP as a non-limiting example of document mark-up language commands; they may optionally be used for sending/receiving XML (eXtensible Markup Language) documents for example (without limitation).

For example, with regard to the non-limiting example of a security system, the user can optionally define a rule to detect suspected movement in a predefined area. When such a rule is violated an alert will be generated and a predefined response such as triggering an alarm will be activated.

According to other preferred embodiments of the present invention, the framework is implemented for a particular processor architecture or family of architectures. Such an implementation optionally and preferably enables one or more libraries to be provided which support such an architecture or family of architectures.

For the purposes of description only and without any intention of being limiting, such an implementation is described herein according to the preferred embodiment of the “DaVinci” architecture family from Texas Instruments (Texas, USA).

The DaVinci architecture features a DSP (digital signal processor) core and a general purpose core as part of a system on chip (SOC) architecture. One non-limiting example of this architecture combines a C64+ DSP core (digital signal processor) (Texas Instruments, Texas, USA) with an ARM9 general-purpose CPU and integrated peripheral inputs and outputs in order to support digital video applications. Such applications require interaction with hardware components, which is performed by the general purpose CPU, while the DSP processor performs tasks related to digital media processing such as digital video processing. This architecture may optionally be generalized to any single or multi processing core architecture. Such a general type of architecture is also supported by preferred embodiments of the present invention; however, optionally and preferably the framework of the present invention is used for multi core architectures in which at least one core is dedicated and/or specially implemented for processing of video data while at least one other core is dedicated and/or specially implemented for processing of general data. The framework of the present invention preferably supports such an architecture by providing an event manager, video analytics and exemplary code featuring a plurality of illustrative methods which together enable the programmer to easily interact with this architecture and to rapidly create and implement new code.

According to preferred embodiments of the present invention, the video analytics engine will be implemented using the custom xDM framework which is part of the CODEC engine of Texas Instruments, as the DaVinci architecture provides for a basic level of video processing support. The analytics will be implemented on either the DSP or the ARM processor, but is preferably implemented on the DSP processor.

The analytics engine is preferably incorporated in the skeletal application, which preferably provides the analytics engine with the required video frame size and rate. The video resealing is preferably performed by the VPSS re-scaler for example.

According to optional embodiments of the present invention, there is provided a scalable security system comprising at least one board according to the present invention, which may also optionally comprise a plurality of such boards, optionally featuring thousands of video channels.

According to other optional embodiments of the present invention, the framework provides control over TTL (transistor-transistor logic) inputs and outputs. TTL outputs can be used also as what known in the art for “dry contact” controls. For example for enabling integration of external digital alarm sources such as smoke, volume and other detectors as trigger inputs and to control external devices such as alarm and other outputs. The trigger inputs may be used to control the way video and audio are streamed as well as other responses.

According to other preferred embodiments of the present invention, there is provided an OSD engine for supporting the addition of video overlay to the analog and digital video outputs. This engine may optionally and preferably incorporate the on-chip OSD hardware of a particular chip architecture or family of architectures, such as for the Da-Vinci chip as a non-limiting example.

The engine preferably supports the addition of custom OSD, including but not limited to text, lines, polygons and special shapes like arrows, circles etc, each of which is termed herein a “shape”. Each shape preferably has its own handle, to enable fast insertion and removal. The shapes will have several properties, like color, line width (for lines), font (for text) and so forth.

According to other preferred embodiments of the present invention, the framework is preferably able to handle a plurality of alert sources. One will be alerts generated from the analytics engine. Another source will be TTL inputs. Other sources may be inputs from the video sensor (which may for example optionally be one or more of CMOS (complementary metal-oxide semiconductor) or CCD (charge-coupled device), or any other suitable sensor for input).

The framework preferably provides a way to tie the alert sources to responses which will include control of the MMSE from the application and other hardware control functions such as the TTL output. This control mechanism is called Alert Responses.

Each response is preferably applied to one or all alert sources from an alert source family. The control will include ways to start video and audio streams, change the streaming parameters (rate control parameters, frame rate, etc.).

According to still other preferred embodiments, the skeletal application (framework) preferably demonstrates the usage of the OSD engine. It embeds text, lines and other objects on the video before it is streamed or sent to the analog video output. This demonstration provides a sample for the integrator to display the integrator's own data on the video as a response to analytics alerts or any other on-the-fly data.

The principles and operation of the present invention may be better understood with reference to the drawings and the accompanying description.

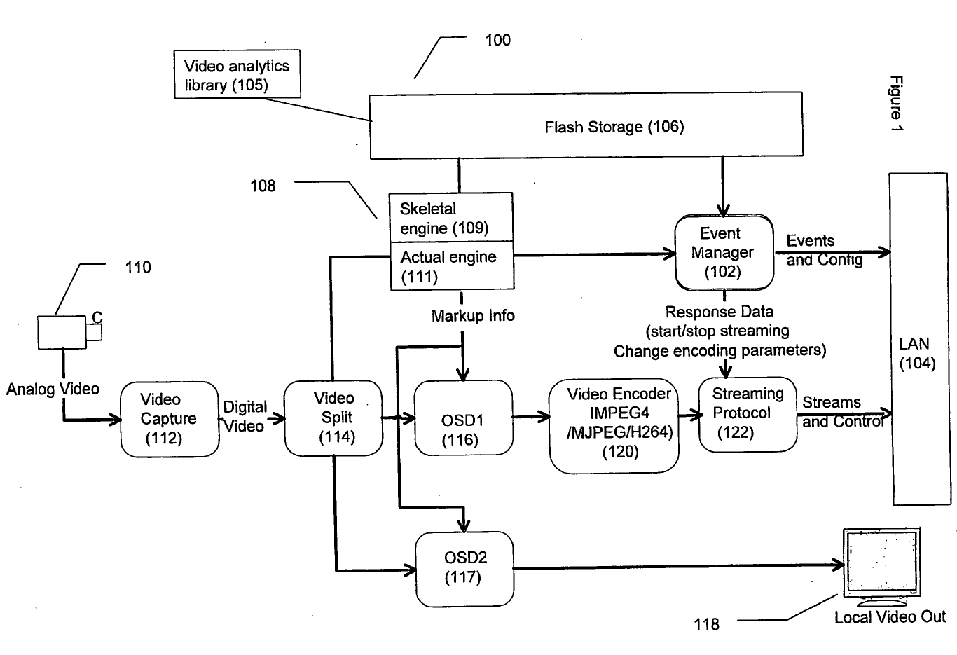

Referring now to the drawings, FIG. 1 is a schematic block diagram of an exemplary, illustrative system according to preferred embodiments of the present invention. A description is provided with regard to streaming video data for the purpose of illustration only and without intending to be limiting in any way.

As shown, a system 100 features a plurality of hardware inputs as well as software components according to optional but preferred embodiments of the present invention. System 100 preferably features an event manager 102 for handling both the plurality of hardware inputs and also for managing outputs from the software components, more preferably including but not limited to determining whether to start or stop streaming data to an external component and/or whether to change one or more parameters for streaming data. For example, event manager 102 is preferably in communication with an external network 104, shown as a LAN (local area network) for the sake of description only and without any intention of being limiting. Event manager 102 is also preferably in communication with a storage device 106, shown as a flash storage device for the sake of description only and without any intention of being limiting, for the purpose of storing and retrieving data regarding events.

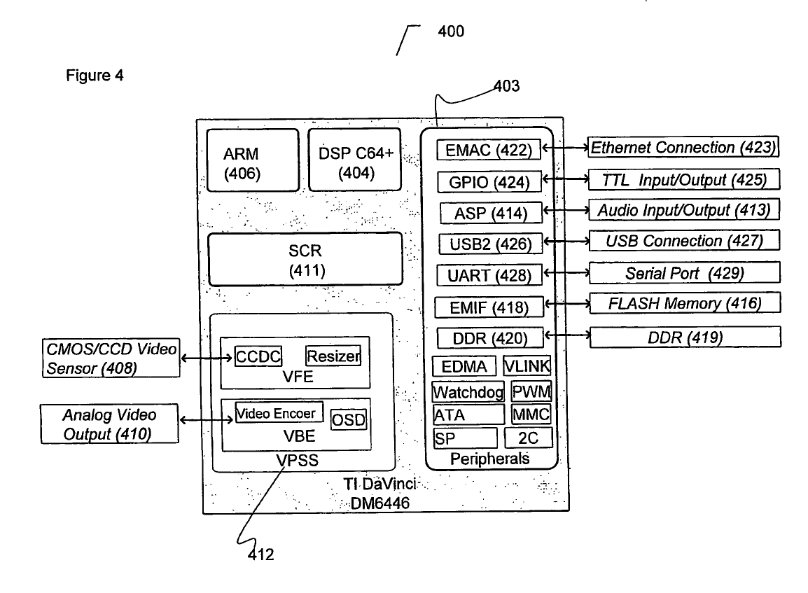

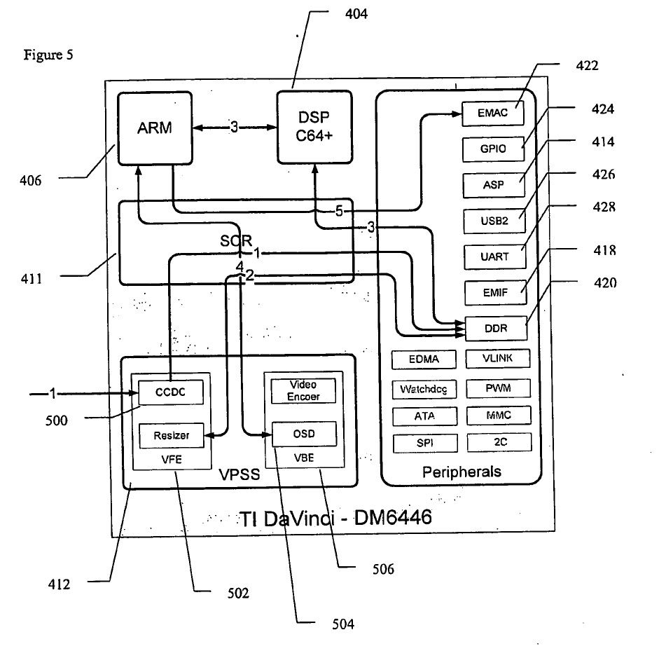

Event manager 102 is also preferably in communication with a video analytics engine 108, which is more preferably inserted into or provided with a wrapper by a skeletal video analytics engine 109. Skeletal video analytics engine 109 according to the present invention preferably provides an interface to the actual video analytics engine 111, such that video analytics engine 108 preferably comprises a combination of the interface according to the present invention (skeletal video analytics engine 109) and an actual video analytics engine 111. Therefore, the actual video analytics engine 111 which forms part of video analytics engine 108 as shown may optionally be modified or replaced by a different engine. Skeletal video analytics engine 109 which forms part of video analytics engine 108 preferably features a plurality of software hooks to various functions for system 100, for ease of customizable programming. Non-limiting examples of such hooks include a video grab hook to allow a new video frame to be “grabbed” and a message transport hook, which may optionally be used to send messages, such as alerts. These hooks are preferably specific to the hardware architecture, for example as described with regard to FIGS. 4 and 5, to provide a standard interface to the hardware.

Video analytics engine 108 also preferably comprises a video analytics library 105, optionally stored on storage device 106 as shown, for supporting the functions of video analytics engine 108. Video analytics library 105 may optionally comprise any such library as is known in the art. Non-limiting examples of such libraries include that of OnBoard software from ObjectVideo Inc (Reston, Va. USA), the IQ series of products from iOmniscient Pty Ltd (Australia), the Intelligent Video software products of Aimetis Corp (Canada) and CamSmartz from Vigilant Video Inc (Pleasanton Calif., USA), although of course other libraries could also optionally be used, additionally or alternatively. These libraries enable video analytics engine 108 to determine whether incoming data represents a detectable object and/or event, and to respond accordingly.

Skeletal video analytics engine 109 may optionally and preferably support a wide variety of video analytics software and/or methods which are known in the art, including those which may optionally be purchased commercially. Examples of such software include but are not limited to OnBoard software from ObjectVideo Inc (Reston, Va. USA), the IQ series of products from iOmniscient Pty Ltd (Australia), the Intelligent Video software products of Aimetis Corp (Canada) and CamSmartz from Vigilant Video Inc (Pleasanton Calif., USA). Many other such examples of software are commercially available and may optionally be implemented with the present invention, additionally or alternatively. Although many examples of such software relate to security applications, in fact any such video analytics software may optionally be used as part of video analytics engine 108 according to the present invention, regardless of the application. Non-limiting examples of relevant fields include banking, retail commerce, energy usage in a room and/or building and/or building complex, behavioral analysis (preferably for human but optionally for non-human behavior, as for animal husbandry for example), face recognition applications, gaming and transportation, and the like.

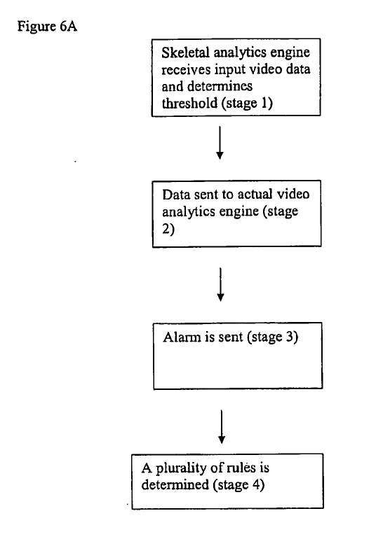

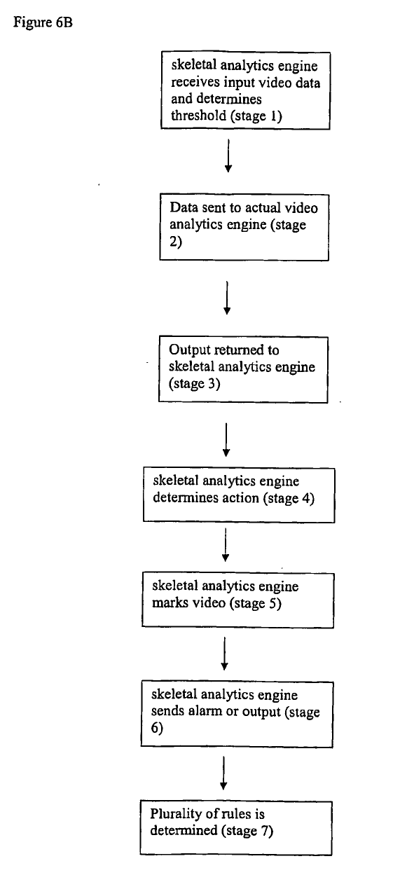

Without wishing to be limited in any way, it should be noted that skeletal video analytics engine 109 may optionally (for example) interact with actual video analytics engine 111 in terms of detecting a threshold in the data, for example a threshold of a predefined parameter in the data, as described with regard to FIG. 6. If a minimum threshold is detected by skeletal video analytics engine 109, then preferably the data and/or another signal is provided to actual video analytics engine 111 for further processing. Skeletal video analytics engine 109 may optionally also feature additional processing capabilities, for example for determining segmentation of video data for searching for targets, as described with regard to US published Patent Application No. 20070127774 to ObjectVideo, hereby incorporated by reference as if fully set forth herein. Once the preprocessing is performed, and optionally only if a threshold and/or other requirement is met, the data is then transferred to actual video analytics engine 111 for further processing and/or to determine whether an additional action or actions should be performed.

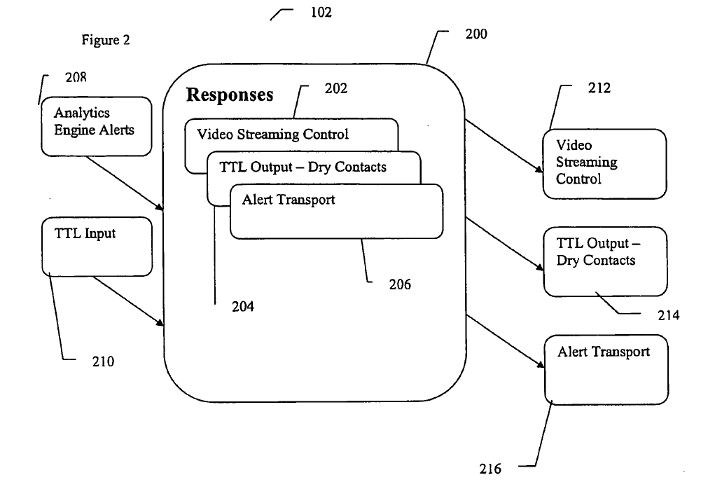

Events from video analytics engine 108 are preferably handled by event manager 102, which determines the action or actions to be performed, preferably including with regard to streaming video data to external network 104. Event manager 102 may optionally and preferably be based upon an input (alert)—rule—response logic, in which an incoming alert or other input causes an analysis to be performed to see which rule such an alert or other input most closely matches. A response is then preferably performed according to the rule; the response may optionally also include taking no action, or may alternatively optionally include various types of actions, which may optionally include but are not limited to providing video data. Event manager 102 is described in more detail in FIG. 2.

Streaming video data is optionally and preferably input to system 100 from a video device 110, shown as an analog camera device for the purpose of illustration only and without any intention of being limiting. Analog video data is captured from video device 110 through a video capture module 112, which preferably outputs digital video data as shown. The digital video data is then preferably input to a video splitter 114, which provides the data to video analytics engine 108 as well as preferably to an OSD engine 1 116 and OSD engine 2 117. The split enables video analytics engine 108 to process the video data as well as providing for the possibility of overlay from OSD (on screen display) engine 1 116 and OSD engine 2 117. As described above, video analytics engine 108 preferably comprises an interface according to the present invention, and a video analytics engine software and/or methods which may optionally be commercially available software for example. The interface according to the present invention preferably receives the video data and passes it to the video analytics engine software and/or methods for further processing as is know in the art.

OSD engine 2 117 optionally and preferably controls the display of video data, for example on a local video output 118. Video analytics engine 108 preferably provides data to OSD engine 2 117, more preferably including mark-up data.

OSD engine 1 116 may optionally provide video data, optionally and preferably including overlay information, to a video encoder 120. Video encoder 120 optionally and preferably operates according to a plurality of different video encoding protocols, including but not limited to one or more of MPEG4, MJPEG and/or H.264.

Video encoder 120 preferably then provides data to a video server 122 for streaming out to external network 104. Video server 122 may optionally be implemented as any type of streaming video server and is shown as a streaming protocol provider for the purpose of description only and without any intention of being limiting. Video server 122 preferably operates as a RTP/RTSP (real time transport protocol/real time streaming protocol) server. RTSP allows control of streaming media from remote (for example, from a client connected to external network 104 (not shown)). RTP/RTSP servers use the real time transport protocol for data delivery but optionally the proprietary RDT protocol of RealNetworks (USA) may be used.

FIG. 2 is a schematic block diagram of an exemplary, illustrative event manager of FIG. 1 according to the present invention in more detail. As shown, event manager 102 preferably features a response analyzer 200 for analyzing incoming data through one or more types of inputs and for determining a response. As previously described, event manager 102 is preferably operative according to an input or alert—rule—response logic, such that response analyzer 200 preferably determines which rule most closely matches the input or alert. If no rule matches, then response analyzer 200 may optionally issue an alarm as described in greater detail below. If a rule matches, then response analyzer 200 preferably determines the correct response, which may optionally comprise taking no action.

Response analyzer 200 preferably comprises a video streaming control response 202, if the action to be taken features one or more commands for video streaming, including but not limited to changing the bit rate of streamed video data, triggering a video timing control (for example to start recording video data), changing frame rate and/or changing the rate control mode. Video streaming control response 202 in turn then preferably outputs one or more commands for taking one or more actions according to the selected response to a video streaming control 212.

Response analyzer 200 also preferably comprises a TTL output response 204, also known in the art as “dry contact response”, if the action to be taken features communication with a physical device, including but not limited to a video camera (with regard to movement of the camera for example), a gate or door, a light or any other physical device. TTL output response 204 in turn preferably outputs one or more commands for taking one or more actions according to the selected response to a TTL output 214. TTL output 214 relates to “dry contact” controls, which for example may optionally be used to issue an alarm or another type of response (frequently an electronically implemented response).

Response analyzer 200 also preferably comprises an alert transport response 206 if the action to be taken features sending one or more alert messages, for example by e-mail, SMS (text messaging), having an automated message delivered by a voice telephony method or protocol, and/or any other type of messaging. Alert transport response 206 in turn preferably outputs one or more commands for sending one or more alerts to an alert transport 216.

On the input side, event manager 102 preferably comprises an analytics engine alert input 208 and a TTL input 210. Analytics engine alert input 208 optionally and preferably comprises any input from the previously described video analytics engine, and may optionally and preferably include any type of image analysis and/or video data analysis. Without wishing to be limited in any way, typically such analysis is more comprehensive and sophisticated than simple motion detection. For example as described with regard to FIG. 1, the video analytics engine may optionally perform target detection and/or other types of analyses, such that analytics engine alert input 208 preferably relates to the output of any such analysis process.

TTL input 210 may optionally include any type of input from any type of physical device, including but not limited to a smoke and/or other air-borne substance detector; a volume detector; a motion detector; a moisture detector; an audio detector; and so forth. The term “TTL” stands for transistor-transistor logic, for example for enabling integration of external detectors such as smoke, volume and other detectors as trigger inputs.

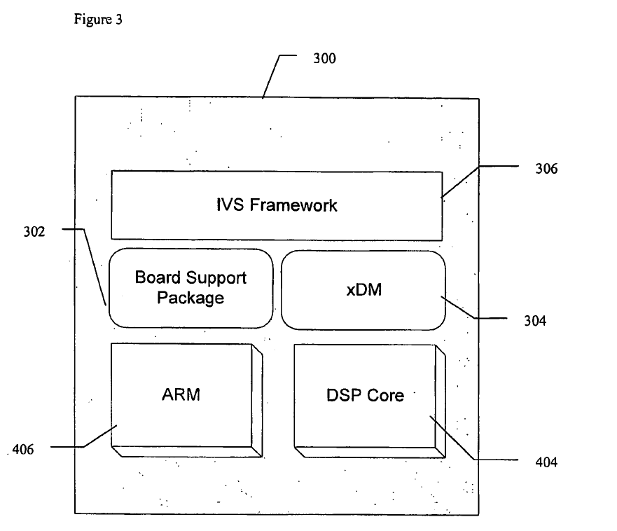

FIG. 3 is a highly schematic block logic diagram of an exemplary, illustrative board implementing the system of FIG. 1 according to the present invention. A more detailed description and diagram is provided below with regard to FIG. 4.

As shown in FIG. 3, a board 300 according to the present invention preferably features a DSP processor 404 (which is preferably dedicated to analyzing video data) and a general purpose processor 406, as an example of a multi-core processor for implementation with the present invention. These processors in turn preferably communicate with a board support package 302 for providing software/algorithmic tools and/or hardware components required for implementing board 300. Exemplary hardware components are described in greater detail below. Exemplary software/algorithmic tools may optionally depend upon the architecture of the processors; for the DaVinci architecture for example, such tools may optionally include any such tool as provided by the manufacturer.

XDM 304 is an exemplary interface to DSP processor 404 as implemented according to the DaVinci architecture; however, the principles described herein are generally applicable to any type of processor architecture. xDM is the eXpressDSP Algorithm Interface Standard for Digital Media of Texas Instruments (USA). XDM 304 thereby provides a generic interface to DSP processor 404, preferably providing such interfaces and codec algorithms for video, image, speech, and audio classes of data. As implemented for the DaVinci architecture, one set of APIs (application programming interfaces) is provided for each class of data, thereby enabling different types of protocols and/or codecs and/or software engines (such as video analytics engines for example) to be easily swapped and implemented. However, one difficulty with such an interface is that it features a fixed standard; as stated in the “Codec Engine Application Developer User's Guide”, literature number SPRUE67B of Texas Instruments (October 2006), the programmer must comply with the standard or else must supply CODEC engine skeletons and stubs.

This problem is overcome by the present invention, specifically for the above architecture but generally for any such architecture in which a DSP interface is provided according to a particular standard, by providing a higher level DSP interface.

Higher level DSP interface enables any programmer to interact with XDM 304 without be limited to the described standard. Higher level DSP interface preferably forms part of IVS framework 306, which is the framework described in greater detail in FIG. 1 (in relation to FIG. 1, higher level DSP interface is preferably part of the video analytics engine shown).

Higher level DSP interface preferably includes a plurality of software hooks and also an overall framework into which any type of video processing method and/or software, such as a video analytics engine, may optionally be introduced. For operation with the exemplary, illustrative and non-limiting DaVinci architecture, the video analytics engine preferably communicates with the skeletal engine according to the present invention, which functions as a higher level interface. This higher level interface is preferably provided with software hooks and other tools for ease of use by the programmer. In turn, this higher level interface preferably communicates with any interface provided by the chip manufacturer, which for the non-limiting example shown is XDM 304.

Any type of video analytics engine may optionally be used with the present invention as previously described. In general and without any wish to be limiting, video analytics preferably includes one or more methods to filter and manage video data, particularly real time video data, for a variety of applications, including but not limited to security and intelligent traffic monitoring.

FIG. 4 shows a schematic block diagram of an exemplary, illustrative board implementing the system of FIG. 1. As shown, a board 400 preferably features a multi-processor architecture chip 402, which more preferably features DSP processor 404 and general purpose processor 406 as previously described. Multi-processor architecture chip 402 may optionally be implemented as a DaVinci chip as shown. Board 400 preferably features a video processing subsystem 412, an SCR 411 and a plurality of peripheral controllers, shown as peripherals 403 for the purpose of illustration only and without any intention of being limiting.

SCR 411 is a Switched Central Resource (SCR) which acts as a crossbar and allows simultaneous data paths between pairs of interfaces and processing elements for DSP processor 404 and general purpose processor 406.

Board 400 is preferably adapted to receive video data from a video input 408 (shown as a CMOS/CCD video sensor for the purposes of illustration only and without any intention of being limiting) and to output data to a video output 410 as shown. Such video data is preferably received by a video processing subsystem 412, which more preferably incorporates the video analytics engine of FIG. 1. The video data is preferably processed once to capture the actual data, and then again to encode and send. Video processing subsystem 412 preferably communicates with the WE (video front end) of DSP 404 and with the VBE (video back end) of DSP 404 as shown, more preferably through a high level video interface as previously described. Audio data is preferably input and output through an audio controller 414 to an audio input/output port 413.

DSP processor 404 preferably controls video processing subsystem 412 and audio controller 414, as well as one or more different types of memory, including but not limited to a flash memory controller 418 for controlling a flash memory 416 for initializing board 400 (preferably controlled through an external memory interface (EMIF) as shown) and/or a RAM 420, such as a DDR2 RAM/SDRAM memory for example, controlled through a RAM controller 419 as shown. RAM 420 is the runtime memory used both by the general purpose processor 406 and DSP processor 404, more preferably for both program and data.

General purpose processor 406 preferably controls communication with other types of external devices such as the external network (not shown) through an EMAC controller 423 for controlling an Ethernet connector 422, for example for sending video data from video processing subsystem 412, alarms, messages and so forth as described herein.

General purpose processor 406 also preferably controls communication with a GPIO (general purpose in/out) device 424, which preferably handles the TTL inputs and outputs 425 as shown. Handling such inputs and outputs enables digital inputs such as smoke detectors, dry contacts and so forth to be read, as well as permitting control of digitally controlled equipment such as sirens, electrical locks and so forth. GPIO device 424 may also optionally be used by the application as a trigger input (for responding to external sensors status change). Also, GPIO device 424 may be used to respond to analytics events (activating alarms, controlling doors and so forth).

General purpose processor 406 may also optionally control other types of ports such as a USB port controller 426 to a USB connection 427 as shown and/or a UART 428 (universal asynchronous receiver/transmitter) to a serial port 429 also as shown. A camera which may optionally be used with board 400 (not shown) optionally and preferably includes an RS232 serial connection. This connection allows terminal based access to the unit for basic maintenance operations. Basic operations include but are not limited to network parameter setting, camera reset, PTZ operations etc.

Board 400 may optionally and preferably be implemented as a “smart” video camera board, for example for surveillance and/or security applications.

FIG. 5 shows an exemplary data flow for an exemplary and optional chip architecture that is operative with the present invention. The data flow also relates to processes for operation with board 400 of the present invention. FIG. 5 demonstrates the data path of five major processes for some embodiments of the framework according to the present invention. Each data flow is designated by a directional or bi-directional numbered arrow or arrows.

As shown, general processor 406 and DSP processor 404 both use SCR 411 to access both VPSS (Video Processing Sub System) 412 and peripherals 403. Hence most of the data paths are running through SCR 411.

The data flow may be controlled by both general processor 406 and DSP processor 404.

Arrow 1 relates to Video Input, in which video data is captured by CCDC (CCD and CMOS controller) 500 in the Video Front End (VFE) 502 to RAM memory (not shown) through RAM controller 420. Arrow 2 relates to video resizing, in which captured video data may optionally be resized from memory or directly from CCDC 500. The framework of the present invention preferably stores the original video data and also more preferably creates a resized image to allow processing of video data in more than one size.

Arrow 3 relates to algorithm flow, for performing one or more video analytics processes and/or event management processes according to the present invention as previously described, preferably by using the captured video data (original size or resized). Such processes may optionally be performed by one or both of general processor 406 and DSP processor 404. Data is preferably read from RAM (not shown), processed and then stored again in memory. The processing is preferably performed as previously described for the IVC framework according to the present invention.

Arrow 4 relates to OSD update, in which information extracted from the above processing of video data is preferably used to update OSD 504 in VBE 406 (both components were previously described), more preferably to obtain an image with OSD information, which may optionally be used for both video output and video streaming.

Arrow 5 relates to alert/message generation, which as previously described may optionally involve sending an alert or any other message over the network as a result of the latest video frame processing. Data flows from at least one of general processor 406 or DSP processor 404 to EMAC 422, and sent over the network (not shown).

FIGS. 6A and 6B show two exemplary, illustrative methods for implementing a video analytics engine according to FIG. 1. Preferably, the video analytics engine comprises at least two portions as described above; a skeletal analytics engine, which may optionally operate with any suitable video analytics engine as is known in the art, and the video analytics engine itself. In FIG. 6A, the skeletal analytics engine performs preprocessing, while further processing is optionally performed by the video analytics engine itself. In FIG. 6B, the skeletal analytics engine performs preprocessing (ie before any processing by the video analytics engine itself) and also post-processing, after optional processing by the video analytics engine.

In stage 1 of FIG. 6A as shown, the skeletal analytics engine preferably receives input video data and determines a threshold value, preferably for a predetermined parameter of the data.

If the data passes the threshold, then the data is sent to the actual or “regular” video analytics engine for further processing in stage 2. For example, if a particular data value is reached then an alarm may optionally be sent and/or other actions taken according to the rules in stage 3. Preferably, the alarm and/or another signal is sent to the event manager, as shown in FIG. 1.

In stage 4, optionally a plurality of rules is determined for each of a plurality of threshold levels, such that as each threshold level is reached, the skeletal analytics engine may optionally send a different and/or additive signal to the actual video analytics engine. Of course, stage 4 may optionally be performed at any time, including before stage 1 is performed, and/or may optionally be performed more than once. The rules may optionally be determined according to a template provided with the skeletal analytics engine.

Turning now to FIG. 6B as shown, stages 1 and 2 are performed as for FIG. 6A. In stage 3, further output of any processing by the video analytics engine is preferably passed back to the skeletal framework. In stage 4, the skeletal framework preferably determines whether an action is to be taken, for example sending the output to a recipient device and/or module, and/or sending an alarm. In stage 5, optionally, the skeletal framework first places an optional marking or mark-up on the video output (digital and analog may both optionally be so marked). In stage 6, the framework preferably sends the output and/or an alarm to the recipient.

In stage 7, as for stage 4 in FIG. 6A, optionally a plurality of rules is determined for each of a plurality of threshold levels, such that as each threshold level is reached, the skeletal analytics engine may optionally send a different and/or additive signal to the actual video analytics engine. Of course, stage 7 may optionally be performed at any time, including before stage 1 is performed, and/or may optionally be performed more than once. The rules may optionally be determined according to a template provided with the skeletal analytics engine.

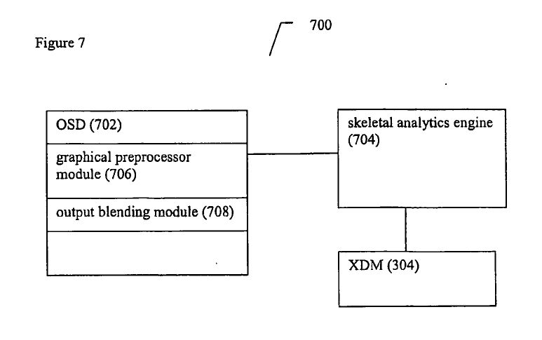

FIG. 7 shows an exemplary, illustrative schematic block diagram of a portion of a system for implementing the OSD engine according to the present invention. As shown, a system 700 features an OSD engine 702 according to the present invention, which may optionally be implemented as described previously. OSD engine 702 preferably communicates with, and more preferably is controlled by, a skeletal analytics engine 704 according to the present invention, which may optionally be implemented as previously described. In turn, skeletal analytics engine 704 preferably communicates with XDM 304 according to the DaVinci architecture as shown, although of course any higher level DSP interface could optionally be used in place of the XDM interface as previously described.

OSD engine 702 preferably supports the addition of graphical and textual overlay to a video output (whether analog and/or digital). OSD engine 702 operates frame to frame, meaning that for each frame the OSD graphics are blended on the video, prior to sending the data to the network (as an RTP stream for example; not shown) or sending it to a local analog display (not shown). The following graphic entities may optionally be added to the video: text; bitmaps; and lines. If an item is not changed for a given frame, some processing may be applied by OSD engine 702 for a particular entity only after it changes.

OSD engine 702 preferably features a graphical preprocessor module 706 and an output blending module 708. Graphical preprocessor module 706 preferably performs the processing for the above entities, whether frame by frame and/or when such an entity changes. Output blending module 708 preferably prepares the blended output (of the input video data and the overlay as prepared by graphical preprocessor module 706), more preferably on a frame by frame basis. If a video overlay feature is enabled for the analog video out, then the hardware OSD module in the previously described architecture, such as the DaVinci VPBE, is preferably used to blend the overlay on the video out for display to a screen (not shown). If the video overlay feature is enabled for the network stream, output blending module 708 preferably embeds the video data with the overlay by using a separate process. It is preferred to use the hardware OSD module for display to a screen in order to save expensive processor resources; of course for other types of architectures, different implementations may optionally be made.

In order to permit processing to be performed either by the hardware OSD module and/or by OSD engine 702, skeletal analytics engine 704 preferably supports a plurality of different control and integration options. For example, skeletal analytics engine 704 preferably enables or disables the OSD feature (and hence the operation of OSD engine 702) for the analog and digital (network) video outputs. Skeletal analytics engine 704 preferably also provides a configurable callback function, which is more preferably configurable by a programmer (for example). This callback function is optionally and preferably called after each frame is processed, to enable OSD information to be added to the video data which is then provided to the above output options.

Skeletal analytics engine 704 preferably also features a parameterized configuration option to allow a programmer (for example) to configure the OSD entities to be displayed.

System 700 may optionally feature other components; however, they are not shown for the sake of simplicity of description only and without any intention of being limiting.

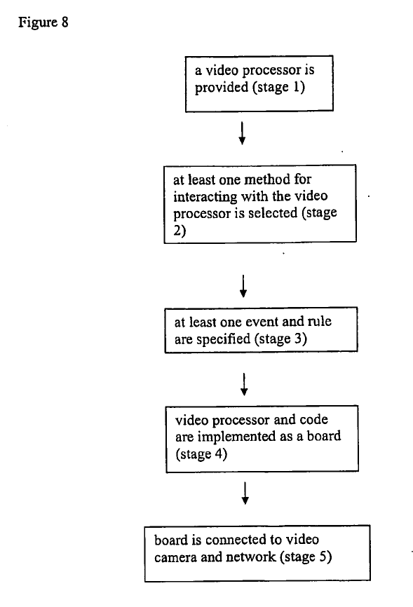

FIG. 8 shows an exemplary, illustrative method for implementing the system according to the present invention as part of an optional security system. The optional security system preferably comprises at least one video camera for gathering video data regarding a location and/or a specific object within the location. The video data is fed to a system according to the present invention for processing. The method thus preferably relates to implementation of processing code with or within the system of the present invention.

In stage 1, a video processor is provided, preferably having an architecture comprising a plurality of cores, in which at least one core is dedicated and/or adapted for processing of video data and at least one core is adapted for general data processing. The video processor is provided with an exemplary embodiment of the framework according to the present invention, which comprises an event manager and a plurality of methods for interacting with the video processor. As a non-limiting illustrative example, the video processor may comprise the DaVinci architecture of Texas Instruments as described herein.

In stage 2, at least one method for interacting with the video processor is selected for implementation, optionally with one or more changes or adaptations.

In stage 3, at least one event is specified for handling by the event manager along with at least one rule for an action to be taken upon the occurrence of the event. For example, if the video camera is intended to detect movement into or out of an area, then the event may optionally be related to movement, while the action may optionally be related to sending an alarm.

In stage 4, the code and the video processor are preferably implemented as a hardware device, which is preferably a board as described in FIG. 4.

In stage 5, the hardware device is preferably connected to a computer network and also to the video camera for receiving video data; optionally the video camera may communicate with the hardware device through the computer network.

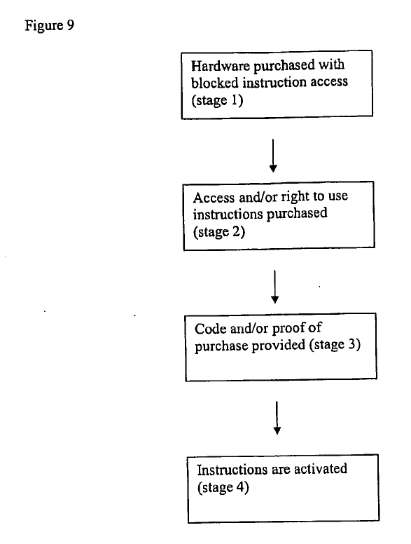

FIG. 9 shows an exemplary, illustrative method for controlling access to instructions provided with hardware according to some embodiments of the present invention. The hardware could optionally be provided in the form of a card and/or as a plurality of components, as described herein. The instructions may optionally be implemented as software and/or firmware. In stage 1, the hardware is purchased with the instructions contained therein but to which access has not yet been provided. The instructions are preferably encapsulated, more preferably with analytics application(s). More preferably, the instructions are tied in their operation and/or implementation to the hardware, with protective methods provided to prevent reverse engineering even at the level of binaries.

In stage 2, access and/or the right to use the instructions are also purchased. Optionally such a purchase may be performed as needed, for a particular length of time for example. Stages 1 and 2 may optionally be performed together or in any order.

In stage 3, a code and/or other proof of purchase is preferably entered locally or to a remote server, for example through any type of computer network, including but not limited to the Internet, a cellular telephone network and so forth. In stage 4, as a response to providing code and/or other proof of purchase, the instructions are preferably activated for operation on/with the hardware.

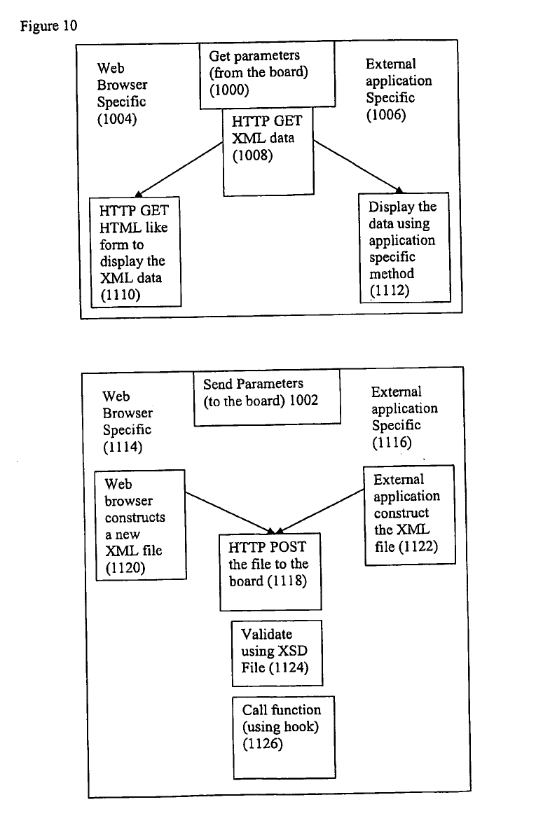

FIG. 10 relates to an exemplary, illustrative method for providing an XML interface for the card/hardware as a standard configurable fully customized API for the web interface. The XML data is to be sent/received to/from the card using standard HTTP commands such as HTTP GET/POST. The use of this method to control the system parameters allows the system parameters to be managed and controlled through the web interface and/or an external application. Both methods use the same HTTP POST/GET interface and the XML file format to control the board parameters. Introducing a single configuration method to an application reduces application conflicts and optimizes the code since only a single control protocol is implemented.

As described above, the web interface uses the XML format and the HTTP POST/GET transport to retrieve the board's configuration. The web interface comprises a set of web pages. Each web page displays one or more XML files. Each web page preferably loads in two stages. The XML data is loaded using the HTTP GET command. The XML data also includes a reference to a user interface file which is automatically loaded by the web browser. The web browser then uses this file to display the data included in the previously received XML data. If the user updates the data in the form and then submits the form, the web browser then builds up a new XML file which is sent to the board using the above standard HTTP POST interface.

The operations above may also be performed (additionally or alternatively) by an external application which uses the same XML API and the same HTTP POST/GET mechanism. This application preferably has its own user interface and does not use the default user interface provided by the board's web server.

The programmer saves an XML Schema Definition (XSD) file for each XML file. This schema file is used to validate the values received from a parameter update, thereby providing a generic method of validating the data sent to the board by the web interface or by an external control application.

The framework allows the programmer to register a software hook upon the change of each XML file. This function is called after the data is validated using the above XSD file.

This interface supports parameter update/retrieval to/from the board and also a way to control the board. The programmer may use this method to register new control operations.

Turning now to FIG. 10 itself, an exemplary “get” process 1000 and an exemplary “send” process 1002 are shown. Get process 1000 may optionally be performed by one or both of a web browser, through a web browser specific process 1004, and/or an external (non web browser) application, through an external application specific process 1006. For both processes 1004 and 1006, an HTTP GET process 1008 is preferably first performed to obtain. XML data. Turning now to web browser specific process 1004, preferably the obtained data is used to construct an HTML like form for displaying the XML data, in a process 1100 preferably performed as described above. For external application specific process 1006, preferably the XML data is prepared for display by using an application specific method, shown as process 1112, which could optionally be performed as described above. Process 1112 is preferably adjusted according to the requirements of the external application.

Turning now to send process 1002, again send process 1002 may optionally be performed by one or both of a web browser, through a web browser specific process 1114, and/or an external (non web browser) application, through an external application specific process 1116. Send process 1002 is preferably used to send parameters to the board, more preferably through a HTTP POST command to send the file to the board, shown as process 1118. Turning now to web browser specific process 1114, preferably the web browser constructs a new XML file in a process 1120 for being sent to the board through the HTTP POST command of process 1118. For external application specific process 1006, preferably the external application is used to construct the XML file in a construction process 1122.

Once process 1118 has been performed, the subsequent actions or processes are preferably the same, regardless of whether web browser specific process 1114 or external application specific process 1116 was initially performed. Next, the file is preferably validated by using an XSD (XML Schema Definition) file in process 1124. XSD is a language for describing and controlling the content of XML files, and so is preferably used for validation of such files.

Next, a function call may optionally be performed, preferably by using a software “hook” as described herein, in process 1126.

While the invention has been described with respect to a limited number of embodiments, it will be appreciated that many variations, modifications and other applications of the invention may be made.

What is claimed is:

1. A method for providing a flexible framework for a video processing infrastructure, comprising:
constructing a skeletal video analytics engine interface; and
building an event manager for managing at least one event according to at least one analytic result provided from said skeletal video analytics engine interface.

2. The method of claim 1, wherein the framework is adapted for use with a video processing infrastructure comprising a plurality of processors, wherein at least one processor is adapted for processing video data and wherein at least one processor is for general data processing.

3. The method of claim 1 or 2, further comprising:
constructing at least one method for supporting at least one interaction between said event manager and at least one peripheral device.

4. The method of any of claims 1-3, wherein said skeletal video analytics engine interface is adapted for operating with a plurality of different video processing infrastructures.

5. The method of any of claims 1-4, wherein said constructing said skeletal video analytics engine interface further comprises constructing a generic customizable interface to said video processing infrastructure.

6. The method of claim 5, wherein said video processing infrastructure comprises at least one of a chip, a core, a chipset, a board or a card, or a combination thereof.

7. The method of claim 5 or 6, wherein said generic customizable interface supports one or more of the following functions: video grabbing and display, video manipulation, audio grab and play, video streaming, audio streaming, dry contact input triggering, dry contact relay output, external device control, and a video overlay function.

8. The method of claim 7, wherein said video manipulation comprises one or more of resealing and frame rate reduction.

9. The method of claim 7 or 8, wherein said external device control comprises control of a video camera.

10. The method of any of claims 7-9, wherein said external device control comprises TTL (transistor-transistor logic) inputs and outputs.

11. The method of any of claims 1-10, wherein the video processing infrastructure comprises the DaVinci architecture.

12. The method of any of claims 1-11, further comprising:
Building a video analytics engine; and
Receiving data by said video analytics engine through said skeletal video analytics engine interface.

13. The method of claim 12, further comprising:
Analyzing said data by said video analytics engine; and
Determining at least one event according to said analyzing for handling by said event manager.

14. The method of claim 13, wherein said determining said at least one event is performed by said video analytics engine.

15. The method of claim 14, wherein said determining said at least one event comprises detecting a threshold in said data by said video analytics engine and if said data is beyond said threshold, determining said at least one event.

16. The method of claim 15, further comprising:
Providing an identified event by said video analytics engine to said skeletal video analytics engine interface; and
Sending said identified event from said skeletal video analytics engine interface to said event manager.

17. The method of claim 13, wherein said determining said at least one event is performed by said event manager.

18. The method of any of claims 13-17, further comprising:
Initiating communication with an external network according to said at least event.

19. The method of claim 18, wherein said initiating said communication comprises streaming video data to said external network.

20. The method of claim 19, wherein said streaming said video data is performed by a multimedia streaming engine (MMSE).

21. The method of claim 1, further comprising:
Building a video analytics engine;
Replacing at least a portion of said skeletal video analytics engine interface with said video analytics engine; and
Connecting said video analytics engine directly to said event manager.

22. A system for implementing a flexible video processing framework for a video analytics engine, comprising:
a. a plurality of processors, wherein at least one processor is adapted for processing video data and wherein at least one processor is for general data processing;
b. a skeletal video analytics engine interface for supporting communication between the video analytics engine and at least said processor adapted for processing video data; and
c. an event manager for managing at least one event according to at least analytic result provided from said skeletal video analytics engine interface.

23. The system of claim 22, further comprising a library featuring a plurality of different functions for extending said skeletal video analytics engine interface.

24. The system of claim 22 or 23, wherein said skeletal video analytics engine interface further comprises at least one software hook for engaging the video analytics engine.

25. The system of any of claims 22-24, wherein said plurality of processors is constructed according to the DaVinci architecture.

26. The system of claim 22, further comprising a video camera for providing video data to said skeletal video analytics engine interface.

27. The system of any of claims 22-26, further comprising a network interface for interacting with an external computer network.

28. The system of claim 27, further comprising a multimedia streaming engine (MMSE), wherein said skeletal video analytics engine interface supports communication between said MMSE and said processors.

29. The system of claim 28, wherein said MMSE streams video data through said external network upon detection of a triggering event by said event manager.

30. The system of claim 28 or 29, wherein said MMSE supports one or both of RTP (Real Time Transport protocol) streaming transport protocol and RTSP (Real Time Streaming Protocol) control protocol.

31. The system of any of claims 22-30, further comprising an OSD (on screen display) engine for interacting with said skeletal video analytics engine interface.

32. The system of any of claims 22-31, wherein said event manager further comprises a response analyzer for comparing an event to at least one rule, and for determining at least one response according to said comparing.

33. The system of claim 32, wherein said response analyzer further comprises a message transporter for sending a message for said response.

34. The system of claim 33, wherein said message transporter operates according to at least one of e-mail, SMS (text messaging), and delivering an automated message by a voice telephony method.

35. The system of any of claims 32-34, wherein said response analyzer further comprises a TTL output response.

36. The system of any of claims 32-35, wherein said event manager further comprises a TTL input for receiving transistor-transistor logic input, for combining with said analyzed video data by said response analyzer.

37. A board for implementing the system of any of claims 22-36.

38. A security system comprising the system of any of claims 22-36, at least one a video camera for providing video data to said skeletal video analytics engine interface and at least one device adapted for TTL input and/or output.

39. A method for communication between a user interface and a chip architecture, wherein said architecture comprises a memory and a plurality of processors, wherein at least one processor is adapted for processing video data and wherein at least one processor is for general data processing, the method comprising:
Constructing a skeletal interface for supporting communication with the processors;
Sending a command through said skeletal interface to obtain data from the memory; and
Providing said data to the user interface through said skeletal interface.

40. The method of claim 39, wherein said command comprises a HTTP GET command.

41. The method of claim 40, further comprising:
Sending data to said processors through said skeletal interface.

42. The method of claim 41, wherein said sending said data is performed according to a HTTP POST command.

43. The method of any of claims 39-42, wherein the user interface comprises a web browser.

44. The method of any of claims 41-43, wherein said sent data comprises at least one configuration command.

45. The method of any of claims 39-44, wherein said skeletal interface forms a part of said skeletal video analytics interface according to any of the preceding claims.

46. A method for controlling access to instructions provided with hardware, comprising:
Providing hardware with instructions, wherein access to said instructions is blocked;
Receiving a code for accessing said instructions; and
Providing said code to said hardware to access said instructions.

47. The method of claim 46, wherein said receiving said code further comprises purchasing access to said instructions.

48. The method of claim 47, wherein said hardware is provided in the form of a card and/or as a plurality of components.

49. The method of claim 48, wherein said hardware comprises a plurality of processors, wherein at least one processor is adapted for processing video data and wherein at least one processor is for general data processing.

50. The method of claim 49, wherein said hardware is constructed according to the DaVinci architecture.
